(19) United States
(12) Patent Application Publication
(10) Pub. No.: US 2013/0336016 A1
(43) Pub. Date: Dec. 19, 2013

(54) SWITCHING POWER-SUPPLY DEVICE

(71) Applicant: Murata Manufacturing Co., Ltd., Nagaokakyo-shi (JP)

(72) Inventor: Hajime SHIJI, Nagaokakyo-shi (JP)

(21) Appl. No.: 13/910,146

(22) Filed: Jun. 5, 2013

(30) Foreign Application Priority Data
Jun. 14, 2012 (JP) 2012-134344

(51) Int. Cl. H02M 3/335

(52) U.S. Cl. CPC H02M 3/33507
USPC 363/21.02

(57) ABSTRACT

A half-bridge converter circuit generates an output voltage from an input voltage, by switching first and second FETs. A subsequent-stage switching control circuit alternately subjects the first and second FETs in the half-bridge converter circuit to on/off control with a fixed on-duty ratio and with a switching frequency corresponding to the weight of a load and a dead time sandwiched therebetween. A boost converter circuit includes an inductor, a smoothing capacitor, and a third FET switching the energization of the inductor. A previous-stage switching control circuit subjects the third FET in the boost converter circuit to on/off control with a controlled on-duty ratio, and adjusts the output voltage of the half-bridge converter circuit.

### BACKGROUND OF THE INVENTION

1. Field of the Invention

The present invention relates to a switching power-supply device that includes a converter with a two-stage configuration.

2. Description of the Related Art

In Japanese Unexamined Patent Application Publication No. 64-43062, a DC-DC converter is disclosed that includes a current-input-type converter provided in a previous stage and a series resonant converter provided in a subsequent stage. The current-input-type converter located at the previous stage is, for example, a boost converter, detects an output voltage, and controls the DC-DC converter so that an input voltage to the series resonant converter located at the subsequent stage it at a particular level. The series resonant converter located at the subsequent stage operates with a fixed frequency so that the input voltage is a load voltage that does not change.

Regardless of the weight of the load, the DC-DC converter described in Japanese Unexamined Patent Application Publication No. 64-43062 sets the switching frequency of the series resonant converter to a fixed resonant frequency, and controls the on-duty ratio of a switch element. Specifically, a pulse width is narrowed in the case of a light load, and the pulse width is widened in the case of a heavy load. However, when the switching frequency has been fixed and the pulse width has been narrowed, that is, when the on-duty ratio has been reduced, there is a problem in that the off-period of the switch element is increased and a switching loss is large. In addition, when the pulse width has been widened in the case of a heavy load and the on-duty ratio of the switch element has been increased, there is a problem in that the amplitude of a current flowing in each element becomes large and a conduction loss (RI²) increases. In this manner, in the DC-DC converter described in Japanese Unexamined Patent Application Publication No. 64-43062, there is a problem in that efficiency is reduced and/or a loss is increased depending on the weight of the load.

### SUMMARY OF THE INVENTION

Preferred embodiments of the present invention provide a switching power-supply device capable of reducing a loss and performing electric power conversion with high efficiency, regardless of the weight of the load.

According to a preferred embodiment of the present invention, a switching power-supply device includes a non-insulated converter arranged to boost an input power supply voltage which is input, and to output a direct-current voltage, and an insulated bridge converter into which the direct-current voltage output from the non-insulated converter is input and that is arranged to output a direct-current voltage to a load, wherein the insulated bridge converter includes a transformer including a primary winding and a secondary winding, an alternating-current voltage generation circuit arranged to be connected to the primary winding, a first switch element and a second switch element, and being arranged to generate and apply to the primary winding an alternating-current voltage from the input direct-current voltage by switching the first switch element and the second switch element, and a rectifier circuit arranged to be connected to the secondary winding and to rectify and output to the load a voltage induced in the secondary winding by magnetic field coupling with the primary winding, the non-insulated converter includes an inductor, a capacitor, and a third switch element arranged to switch energization of the inductor, and the switching power-supply device further includes a switching frequency control circuit arranged to alternately subject the first switch element and the second switch element to on/off control with a dead time sandwiched therebetween, using a fixed on-duty ratio and a switching frequency corresponding to the weight of the load, and a PWM control circuit arranged to subject the third switch element to on/off control, to control an on-duty ratio of the third switch element, and to adjust an output voltage of the insulated bridge converter.

With this configuration, since it is possible to subject the first switch element and the second switch element to on/off control with the on-duty ratio of, for example, about 50%, it is possible to reduce the switching losses of the first switch element and the second switch element, and thus, it is possible to efficiently perform electric power conversion. In addition, the on-duty ratio is fixed, the switching frequency of the first switch element and the second switch element is controlled in response to the weight of a load, and thus, it is possible to reduce a change in a loss due to the switching frequency. For example, by setting the switching frequency to a high level at the time of a heavy load, a pulse width is narrowed, and it is possible to reduce a conduction loss by reducing a current ripple. In addition, by setting the switching frequency to a low level at the time of a light load, it is possible to reduce an iron loss.

It is preferable that the switching frequency control circuit is arranged such that a switching frequency of the first switch element and the second switch element when the load is a light load is less than a switching frequency when the load is a heavy load.

With this configuration, by setting the switching frequency to a high level at the time of a heavy load, a pulse width is narrowed, and it is possible to reduce a conduction loss by reducing a current ripple. In addition, by setting the switching frequency to a low level at the time of a light load, it is possible to reduce an iron loss.

A configuration may also be provided in which the switching frequency control circuit detects an output current to the load, and controls the switching frequency in response to the output current.

With this configuration, the switching frequency is controlled in accordance with the weight of a load, and thus, it may be possible to perform highly efficient electric power conversion, regardless of the weight of a load.

A configuration may also be provided in which the switching frequency control circuit detects a primary-side current flowing in an element provided on a primary side of the transformer, and controls the switching frequency in response to the primary-side current.

With this configuration, while an insulating configuration (a photo coupler or other suitable circuit elements) used to transmit a detection signal from the secondary side to the primary side may be necessary when the current is detected on the secondary side of the transformer, the insulating configuration may be unnecessary by performing current detection on the primary side.

A configuration may also be provided in which the switching frequency control circuit detects a temperature of an element provided on a primary side or a secondary side of the transformer, and controls the switching frequency in response to the temperature.

With this configuration, it is possible to efficiently perform electric power conversion by switching control associated with a temperature change.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a circuit diagram of a switching power-supply device according to a first preferred embodiment of the present invention.

FIG. 2 is a circuit diagram of a switching power-supply device according to a second preferred embodiment of the present invention.

FIG. 3 is a circuit diagram of a switching power-supply device according to a third preferred embodiment of the present invention.

### DETAILED DESCRIPTION OF THE PREFERRED EMBODIMENTS

### First Preferred Embodiment

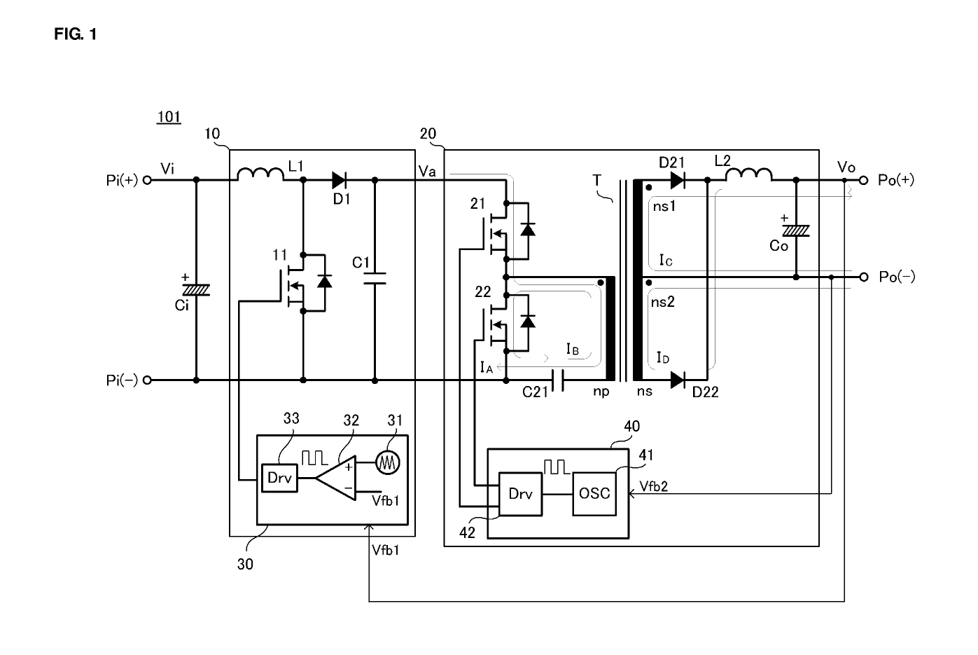

FIG. 1 is the circuit diagram of a switching power-supply device according to a first preferred embodiment of the present invention. A switching power-supply device 101 includes a non-insulated converter in a previous stage and an insulated bridge converter in a subsequent stage. In the present preferred embodiment, the non-insulated converter is preferably a boost converter circuit 10, and the insulated bridge converter is preferably a half-bridge converter circuit 20. The switching power-supply device 101 converts a direct-current input voltage Vi input from input terminals Pi(+) and Pi(−) into an output voltage Vo, and supplies the output voltage Vo to a load (not illustrated) connected to output terminals Po(+) and Po(−). A smoothing capacitor Ci and the boost converter circuit 10 are connected to the input terminals Pi(+) and Pi(−).

The boost converter circuit 10 includes an inductor L1, an n-type MOSFET (hereinafter, referred to as an FET) 11, a diode D1, and the smoothing capacitor C1. The first end of the inductor L1 is connected to the input portion of the boost converter circuit 10, and the second end thereof is connected to the output portion of the boost converter circuit 10 through the diode D1. The anode terminal of the diode D1 is connected to the inductor L1, and the cathode terminal thereof is connected to the output portion of the boost converter circuit 10. The smoothing capacitor C1 is connected to the cathode terminal of the diode D1. The drain terminal of the FET (a third switch element in preferred embodiments of the present invention) 11 is connected to a connection point between the inductor L1 and the diode D1, and the source terminal thereof is connected to a ground line. In addition, the gate terminal of the FET 11 is connected to a previous-stage switching control circuit (hereinafter, referred to as a previous-stage SW control circuit) 30, and the FET 11 is subjected to on/off control by the previous-stage SW control circuit 30. This previous-stage SW control circuit 30 corresponds to a PWM control circuit in preferred embodiments of the present invention.

The FET 11 is turned on or turned off by the previous-stage SW control circuit 30, and thus, the boost converter circuit 10 boosts the input voltage Vi to an output voltage Va. Specifically, when the FET 11 is turned on, energy is accumulated in the inductor L1. In addition, when the FET 11 is turned off, the electromotive voltage of the inductor L1 is added to the input voltage Vi, and the output voltage Va is output.

To the previous-stage SW control circuit 30, a feedback voltage Vfbl is input that corresponds to the output voltage Vo detected on the secondary side of an after-mentioned transformer T. In addition, in FIG. 1, only the path of feedback is simply expressed as one line. For example, feedback may be performed using an insulating mechanism, such as a photo coupler or a pulse transformer. Specifically, a feedback circuit is connected between the output terminals Po(+)-Po(−), and the feedback circuit generates a feedback signal by comparing the voltage-dividing value of a voltage between the output terminals Po(+)-Po(−) with a reference voltage, and inputs the feedback voltage Vfb1 to the previous-stage SW control circuit 30 in an insulated state.

The previous-stage SW control circuit 30 includes an oscillator 31, a comparator 32, and a driver (Dry) 33, and subjects the FET 11 to on/off control with an on-duty ratio decided based on the feedback voltage Vfb1. The oscillator 31 is connected to the non-inverting input terminal (+) of the comparator 32, and outputs a reference wave voltage (ramp wave voltage), which is triangular or substantially triangular, to the comparator 32. The feedback voltage Vfb1 is input to the inverting input end (−) of the comparator 32. The comparator 32 compares the input triangular or substantially-triangular wave voltage with the feedback voltage Vfb1, and generates a PWM signal having a duty corresponding to a comparison result. Based on the PWM signal from the comparator 32, the driver 33 performs on/off control on the FET 11.

In this manner, in the switching power-supply device 101 according to the present preferred embodiment, in the previous-stage SW control circuit 30, the on-duty ratio of the FET 11 is controlled by the feedback voltage Vfbl. In other words, the previous-stage SW control circuit 30 controls the on-duty ratio of the FET 11, and thus, the output voltage Vo of the switching power-supply device 101 is controlled.

The half-bridge converter circuit 20 including the transformer T is connected to the subsequent stage of the boost converter circuit 10. The half-bridge converter circuit 20 includes an FET (a first switch element in preferred embodiments of the present invention) 21, an FET (a second switch element in preferred embodiments of the present invention) 22, and a capacitor C21, on the primary side of the transformer T. An alternating-current voltage generation circuit according to preferred embodiments of the present invention is defined by the FETs 21 and 22 and the capacitor C21.

The drain terminal of the FET 21 is connected to the output portion of the boost converter circuit 10, and the source terminal thereof is connected to the first end of the primary winding np of the transformer T. The second end of the primary winding np is connected to the capacitor 21, and a series circuit is defined by the FET 21, the primary winding np, and the capacitor C21.

The drain terminal of the FET 22 is connected to the first end of the primary winding np, and the source terminal thereof is connected to the second end of the primary winding np through the capacitor C21. A closed-loop circuit is defined by the FET 22, the capacitor C21, and the primary winding np.

The gate terminal of each of the FETs 21 and 22 is connected to a subsequent-stage switching control circuit (hereinafter, referred to as a subsequent-stage SW control circuit) 40, and the FETs 21 and 22 are subjected to on/off control by the subsequent-stage SW control circuit 40. In detail, the FETs 21 and 22 are alternately turned on with the duty ratio of about 50% and a dead time sandwiched therebetween. This subsequent-stage SW control circuit 40 corresponds to a switching frequency control circuit in preferred embodiments of the present invention.

The half-bridge converter circuit 20 includes diodes D21 and D22, a choke coil L2, and a smoothing capacitor Co, on the secondary side of the transformer T. The diodes D21 and D22, the choke coil L2, and the smoothing capacitor Co define a rectifier circuit in preferred embodiments of the present invention. The first end of the secondary winding ns of the transformer T is connected to the anode terminal of the diode D21, and the second end thereof is connected to the anode terminal of the diode D22. The cathode terminal of each of the diodes D21 and D22 is connected to the output terminal Po(+) through the choke coil L2 and the smoothing capacitor Co. In addition, the secondary winding ns of the transformer T includes an intermediate tap, and the intermediate tap is connected to the output terminal Po(−). Hereinafter, for convenience of explanation, the secondary winding ns between the first end and the intermediate tap is referred to as a first secondary winding ns1, and the secondary winding ns between the second end and the intermediate tap is referred to as a second secondary winding ns2.

In the half-bridge converter circuit 20, due to the subsequent-stage SW control circuit 40, the FETs 21 and 22 are alternately turned on with the on-duty ratio of about 50% and a dead time sandwiched therebetween. When the FET 21 is turned on and the FET 22 is turned off, a current I_{A} flows in a path including the FET 21, the primary winding np of the transformer T, and the capacitor C21. When this current flows in the primary winding np, the capacitor C21 is charged, and a voltage is induced in the secondary winding ns of the transformer T by magnetic field coupling. In addition, on the secondary side of the transformer T, a current I_{c} flows through a path including the first secondary winding ns1, the diode D21, and the inductor L2.

When the FET 21 has been turned off and the FET 22 has been turned on with a dead time sandwiched therebetween, the charged capacitor C21 is discharged, and a current I_{B} flows through a path including the primary winding np and the FET 22. When this current flows in the primary winding np, a voltage opposite to the case of the turn-on of the FET 21 is induced in the secondary winding ns of the transformer T by magnetic field coupling. In addition, on the secondary side of the transformer T, a current I_{D} flows through a path including the second secondary winding ns2, the diode D22, and the inductor L2.

A current flowing to a load is detected, and a feedback voltage Vfb2 corresponding to the detection result is input to the subsequent-stage SW control circuit 40. The feedback voltage Vfb2 is detected through, for example, a current detection transformer and a resistor, provided in the connection line of the output terminal Po(−). The current flowing to the load is subjected to voltage conversion by the current detection transformer, and a converted voltage is fed back through the resistor, and input to the subsequent-stage SW control circuit 40. In addition, in the same or substantially the same manner as the feedback voltage Vfb1, the feedback voltage Vfb2 may be fed back using an insulating mechanism, such as a photo coupler or a pulse transformer.

The subsequent-stage SW control circuit 40 includes an oscillator (OSC) 41 and a driver (Dry) 42. The oscillator 41 generates a pulse wave whose on-duty ratio is about 50% and whose frequency corresponds to the input feedback voltage Vfb2, and the oscillator 41 outputs the pulse wave to the driver 42. Specifically, when the load is a light load and the input feedback voltage Vfb2 is large, the oscillator 41 generates the pulse wave whose frequency is lower than the case in which the load is a heavy load. Based on the pulse wave, the driver 42 alternately turns on or turns off the FETs 21 and 22 with a dead time sandwiched therebetween. Accordingly, when the load is a light load, the FETs 21 and 22 are alternately turned on with a low switching frequency and with the on-duty ratio of about 50% and a dead time sandwiched therebetween. In addition, when the load is a heavy load, the FETs 21 and 22 are alternately turned on with a high switching frequency and with the on-duty ratio of about 50% and a dead time sandwiched therebetween.

Since the on-duty ratio is about 50%, it is possible to cause the FETs 21 and 22 to operate with high efficiency, and it is possible to achieve highly efficient electric power conversion. In addition, by setting the switching frequency of the FETs 21 and 22 to a high level at the time of the heavy load, it is possible to reduce the amplitude of a current flowing in each element, and it is possible to reduce a conduction loss in each element. In addition, by setting the switching frequency of the FETs 21 and 22 to a low level at the time of the light load, it is possible to reduce an iron loss.

As described above, in the switching power-supply device 101 according to the present preferred embodiment, the on-duty ratio of the FETs 21 and 22 in the half-bridge converter circuit 20 is fixed to about 50%, and the control of the output voltage Vo is performed by adjusting the on-duty ratio Da of the FET 11 in the boost converter circuit 10. Accordingly, it is possible for the switching power-supply device 101 to perform highly efficient electric power conversion.

Hereinafter, the reason that the output voltage Vo may be controlled by adjusting the on-duty ratio Da of the FET 11 will be described.

In the boost converter circuit 10, when it is assumed that the on-duty ratio of the FET 11 is Da, a relationship between the input voltage Vi and the output voltage Va satisfies the following Expression (1).

Va/Vi=Da/(1−Da) (1)

The output voltage Va of the boost converter circuit 10 is the input voltage of the half-bridge converter circuit 20 connected to the subsequent stage of the boost converter circuit 10. The above-mentioned Expression (1) is expressed with respect to the voltage Va, the following Expression (2) is obtained.

Va=Vi·Da/(1−Da) (2)

In the half-bridge converter circuit 20, when it is assumed that the winding ratio of the transformer T is n and the on-duty ratio of the FETs 21 and 22 is Db, the following Expression (3) is satisfied.

Vo/Va=Db/(2n) (3)

Here, when it is assumed that the winding of the primary winding np is n1 and the winding of the secondary winding np is n2, n=n1/n2 is satisfied. In addition, since the winding n2 of the secondary winding np includes the first secondary winding ns1 and the second secondary winding ns2, dividing by two is performed in the Expression (3). Accordingly, when the secondary winding ns has no intermediate tap, the right side of the Expression (3) is not divided by two. If the Expression (2) is substituted into the Expression (3), the output voltage Vo satisfies the following Expression (4).

Vo={Vi·Da/(1−Da)}·{Db/(2n)} (4)

The on-duty ratio Db of the FETs 21 and 22 is fixed to about 50%. In other words, since the on-duty ratio Db is fixed in the above-mentioned Expression (4), the output voltage Vo may be controlled by the on-duty ratio Da of the FET 11.

### Second Preferred Embodiment

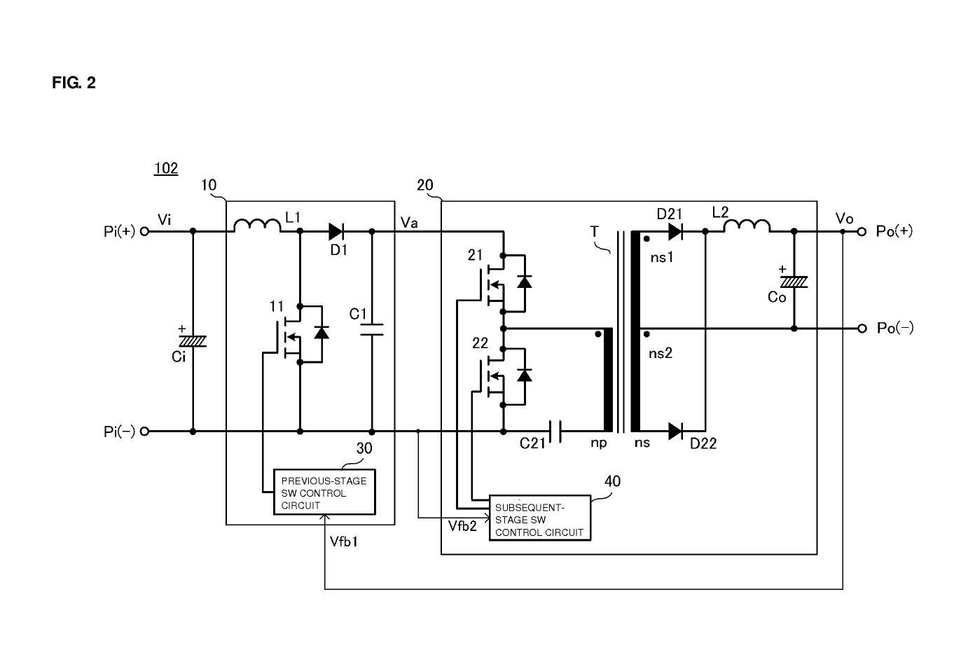

FIG. 2 is the circuit diagram of a switching power-supply device 102 according to a second preferred embodiment of the present invention. While, in the first preferred embodiment, the current flowing in the load is detected on the secondary side of the transformer T, and the feedback voltage Vfb2 is input to the subsequent-stage SW control circuit 40, the second preferred embodiment is different in that a current flowing on the primary side of the transformer T is detected. A point at which the current is detected on the primary side of the transformer T may be arbitrarily changed. For example, a current flowing in the FET 21 or the FET 22 may also be detected, or a current flowing in the primary winding np may also be detected. In addition, a current flowing in the FET 11 may also be detected, or a current flowing in the inductor L1 may also be detected.

In the present preferred embodiment, since the current is detected on the primary side of the transformer T, an insulating mechanism, such as a photo coupler or a pulse transformer, is not necessary.

### Third Preferred Embodiment

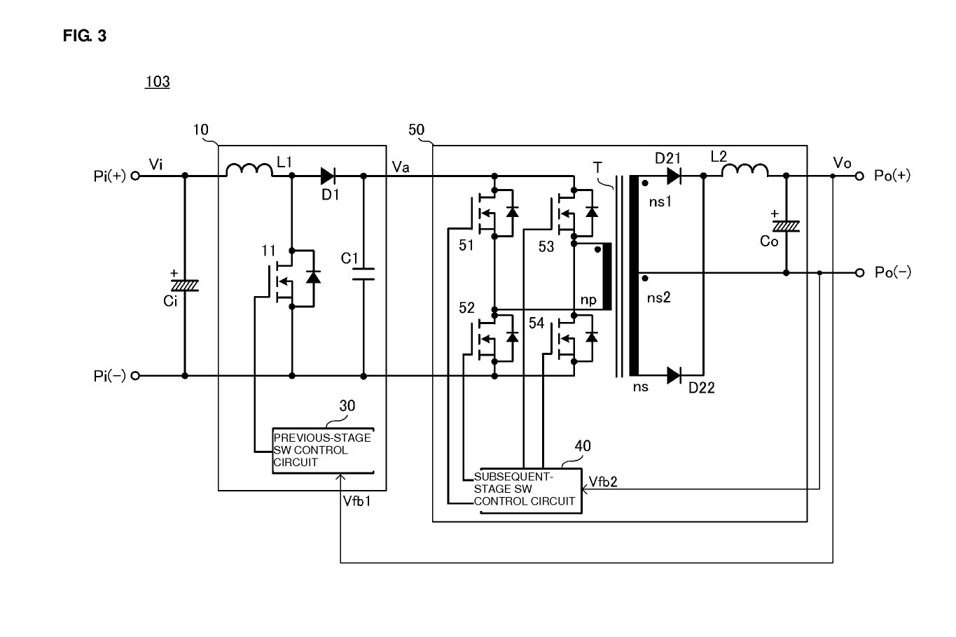

FIG. 3 is the circuit diagram of a switching power-supply device 103 according to a third preferred embodiment of the present invention. In place of the half-bridge converter circuit 20 in the first and second preferred embodiments, the switching power-supply device 103 includes a full-bridge converter circuit 50.

The full-bridge converter circuit 50 includes FETs 51, 52, 53, and 54. The FETs 51, 52, 53, and 54 are arranged in a bridge configuration, and a primary winding np is connected to a connection point between the FETs 51 and 52 and a connection point between the FETs 53 and 54. In detail, a series resonant circuit is defined by the FET 51, the primary winding np, and the FET 54, and is connected to the input portion of the full-bridge converter circuit 50. In addition, a series resonant circuit is defined by the FET 53, the primary winding np, and the FET 52, and is connected to the input portion of the full-bridge converter circuit 50.

In the full-bridge converter circuit 50, the subsequent-stage SW control circuit 40 simultaneously turns on or turns off the FETs 51 and 54, and simultaneously turns on or turns off the FETs 52 and 53. In addition, the subsequent-stage SW control circuit 40 alternately turns on the FETs 51 and 54 and the FETs 52 and 53 with the fixed on-duty ratio of about 50% and a switching frequency controlled in response to the feedback voltage Vfb2.

In addition, in the same or substantially the same manner as in the first preferred embodiment, the output voltage Vo is controlled by adjusting the on-duty ratio of the FET 11 in the boost converter circuit 10.

Even if a full-bridge type DC-DC converter is provided in such a manner as the above-described configuration, it is possible to perform highly efficient electric power conversion in the same or substantially the same manner as the first preferred embodiment.

While the switching power-supply devices according to the first to third preferred embodiments of the present invention have been described, the design of the specific configuration thereof may be arbitrarily changed, and the most suitable functions and effects produced by the preferred embodiments of the present invention have only been listed. In addition, functions and effects of preferred embodiments of the present invention are not limited to the functions and effects described in the first to third preferred embodiments.

For example, in each preferred embodiment, a configuration may also be provided in which the switching power-supply device detects, using a thermistor or other suitable device, the temperature of an element provided on the primary side or the secondary side of the transformer T, for example, an element, such as the inductor L1, the FET 21 or 22, or the diode D21 or D22, and the feedback current Vfb2 to be input to the subsequent-stage SW control circuit 40 is detected.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A switching power-supply device comprising:
a non-insulated converter arranged to boost an input power supply voltage which is input to the non-insulated converter, and output a direct-current voltage; and
an insulated bridge converter into which the direct-current voltage output from the non-insulated converter is input and that is arranged to output a direct-current voltage to a load; wherein
the insulated bridge converter includes:
a transformer including a primary winding and a secondary winding;
an alternating-current voltage generation circuit arranged to be connected to the primary winding, including a first switch element and a second switch element, and arranged to generate and apply to the primary winding an alternating-current voltage from the input direct-current voltage by switching of the first switch element and the second switch element; and
a rectifier circuit arranged to be connected to the secondary winding and to rectify and output to the load a voltage induced in the secondary winding by magnetic field coupling with the primary winding;
the non-insulated converter includes:
an inductor;
a capacitor; and
a third switch element arranged to switch energization of the inductor; and
the switching power-supply device further includes:
a switching frequency control circuit arranged to alternately subject the first switch element and the second switch element to on/off control with a dead time sandwiched therebetween, using a fixed on-duty ratio and a switching frequency corresponding to a weight of the load; and
a PWM control circuit arranged to subject the third switch element to on/off control, to control an on-duty ratio of the third switch element, and to adjust an output voltage of the insulated bridge converter.

2. The switching power-supply device according to claim 1, wherein the switching frequency control circuit is arranged such that a switching frequency of the first switch element and the second switch element when the load is a light load is less than a switching frequency when the load is a heavy load.

3. The switching power-supply device according to claim 1, wherein the switching frequency control circuit is arranged to detect an output current to the load, and to control the switching frequency in response to the output current.

4. The switching power-supply device according to claim 1, wherein the switching frequency control circuit is arranged to detect a primary-side current flowing in an element provided on a primary side of the transformer, and to control the switching frequency in response to the primary-side current.

5. The switching power-supply device according to claim 1, wherein the switching frequency control circuit is arranged to detect a temperature of an element provided on a primary side or a secondary side of the transformer, and to control the switching frequency in response to the temperature detected.

6. The switching power-supply device according to claim 1, wherein the first and second switch elements are FETs.

7. The switching power-supply device according to claim 1, wherein the third switch element is a FET.

8. The switching power-supply device according to claim 1, wherein the non-insulated converter further includes a diode connected in series to the inductor.

9. The switching power-supply device according to claim 8, wherein the third switch element is a FET including a drain terminal connected to a connection point between the inductor and the diode.

10. The switching power-supply device according to claim 1, wherein the PWM control circuit includes an oscillator, a comparator, and a driver.

11. The switching power-supply device according to claim 1, wherein each of the first and second switch elements in an n-type FET.

12. The switching power-supply device according to claim 1, wherein the insulated bridge converter is a half-bridge converter.

13. The switching power-supply device according to claim 1, wherein the insulated bridge converter is a full-bridge converter.

14. The switching power-supply device according to claim 1, wherein the secondary winding includes first and second winding portions.

15. The switching power-supply device according to claim 1, wherein the rectifier circuit of the insulated bridge converter includes first and second diodes and a smoothing capacitor provided on a secondary side of the transformer at which the secondary winding is provided.

16. The switching power-supply device according to claim 15, wherein a first end of the secondary winding of the transformer is connected to an anode terminal of the first diode, and a second end of the secondary winding is connected to an anode terminal of the second diode, and a cathode terminal of each of the first and diodes is connected to an output terminal of the switching power-supply device.

17. The switching power-supply device according to claim 15, wherein the smoothing capacitor is connected to each of a pair output terminals of the switching power-supply device.

18. The switching power-supply device according to claim 1, wherein the secondary winding includes an intermediate tap connected to an output terminal of the switching power-supply device.
